(19) United States
(12) Patent Application Publication
(10) Pub. No.: US 2024/0281213 A1
(43) Pub. Date: Aug. 22, 2024

(54) IMAGE SENSOR, RANDOM NUMBER GENERATION SYSTEM USING THE IMAGE SENSOR

(71) Applicant: SK hynix Inc., Icheon-si Gyeonggi-do (KR)

(72) Inventors: Nam Hyun KIM, Icheon-si Gyeonggi-do (KR); Kang Bong SEO, Icheon-si Gyeonggi-do (KR); Kwang Jun CHO, Icheon-si Gyeonggi-do (KR)

(73) Assignee: SK hynix Inc., Icheon-si Gyeonggi-do (KR)

(21) Appl. No.: 18/504,970

(22) Filed: Nov. 8, 2023

(30) Foreign Application Priority Data
Feb. 20, 2023 (KR) 10-2023-0022321

(51) Int. Cl. G06F 7/58

(52) U.S. Cl. CPC G06F 7/588

(57) ABSTRACT

A random number generation system for generating random number(s) using an image sensor is disclosed. The image sensor includes a photoelectric conversion element configured to generate charges in response to light, a first tap in which a first charge from among the charges generated by the photoelectric conversion element is accumulated, and a second tap in which a second charge from among the charges generated by the photoelectric conversion element is accumulated.

### CROSS-REFERENCE TO RELATED APPLICATION

This patent document claims the priority under 35 U.S.C. § 119(a) to, and benefits of, Korean patent application No. 10-2023-0022321, filed on Feb. 20, 2023, in the Korean Intellectual Property Office, which is hereby incorporated by reference in its entirety as part of the disclosure of this patent document.

### 1. TECHNICAL FIELD

Various embodiments generally relate to a random number generation system, and more particularly, to a random number generation system capable of generating random numbers using an image sensor.

### 2. BACKGROUND

Recently, research and development has been conducted on various security technologies for preventing data exposure during data communication. The most widely used technology among these security technologies is a technology for encrypting data using an encryption key. The encryption key needs to be structured so that others cannot easily infer the encryption key. In order to generate the encryption key, different and unpredictable numbers (i.e., random numbers) are required. A random number generator for generating such random numbers should have excellent randomness with high unpredictability, which is one of the fundamental characteristics of random numbers.

On the other hand, since an image sensor is mainly used in a camera module, if a device having a built-in camera module such as a smart device can generate random numbers using a built-in image sensor, the image sensor may be considered efficient in terms of implementation of a device such as a random number generator.

### SUMMARY

In accordance with an embodiment of the disclosed technology, an image sensor may include: a photoelectric conversion element configured to generate charges in response to light; a first tap in which a first charge from among the charges generated by the photoelectric conversion element is accumulated; and a second tap in which a second charge from among the charges generated by the photoelectric conversion element is accumulated. Here, a ratio of the first charge to the second charge is adjusted in response to a phase difference between irradiation light emitted to a target object and reflected light, and pixel signals respectively corresponding to the first charge and the second charge are provided as a seed value for generating at least one random number.

In accordance with another embodiment of the disclosed technology, a random number generation system may include: an image sensor configured to include a plurality of unit pixels, emit irradiation light to a target object, adjust a ratio of charges to be distributed to floating diffusion nodes of each of the plurality of unit pixels in response to a phase difference between the irradiation light and a reflected light reflected from the target object, and generate seed data by processing digital data corresponding to the ratio of the charges; and a random number generator configured to generate at least one random number in response to the seed data received from the image sensor.

In accordance with another embodiment of the disclosed technology, an image sensor may include: a photoelectric conversion element configured to generate charges in response to light; a first tap in which a first charge from among the charges generated by the photoelectric conversion element is accumulated; and a second tap in which a second charge from among the charges generated by the photoelectric conversion element is accumulated. Here, a total charge accumulated in the first tap and the second tap is equal to a sum of the first charge and the second charge, a ratio of the first charge to the second charge is adjusted in response to a phase difference between irradiation light emitted to a target object and reflected light, and a ratio of noise included in the first charge to noise included in the second charge is provided as a seed value for generating at least one random number.

### BRIEF DESCRIPTION OF THE DRAWINGS

The above and other features and beneficial aspects of the disclosed technology will become readily apparent with reference to the following detailed description when considered in conjunction with the accompanying drawings.

FIG. 1 is a block diagram illustrating an example of a random number generation system using an image sensor based on some embodiments of the disclosed technology.

FIG. 2 is a block diagram illustrating an example of an image sensor shown in FIG. 1 based on some embodiments of the disclosed technology.

FIG. 3 is a circuit diagram illustrating an example of a unit pixel of the image sensor shown in FIG. 2 based on some embodiments of the disclosed technology.

FIG. 4 is a timing diagram illustrating example operations of the unit pixel shown in FIG. 3 based on some embodiments of the disclosed technology.

FIG. 5 is a diagram illustrating an example of potential energy of the unit pixel shown in FIG. 3 based on some embodiments of the disclosed technology.

FIG. 6 is a diagram illustrating an example of Poisson distribution of the unit pixel shown in FIG. 3 based on some embodiments of the disclosed technology.

FIG. 7 is a flowchart illustrating an example method for generating random numbers using the image sensor based on some embodiments of the disclosed technology.

FIG. 8 is a block diagram illustrating an example of a random number generation system using an image sensor based on some other embodiments of the disclosed technology.

FIG. 9 is a schematic diagram illustrating an example of the image sensor shown in FIG. 8 based on some embodiments of the disclosed technology.

FIGS. 10 and 11 are diagrams illustrating examples of a data processor shown in FIG. 9 based on some embodiments of the disclosed technology.

### DETAILED DESCRIPTION

Various embodiments provide implementations and examples of a random number generation system capable of generating random numbers using an image sensor, that may be used in configurations to substantially address one or more technical or engineering issues and to mitigate limitations or disadvantages encountered in other random number generation systems. Some embodiments of the disclosed technology relate to a random number generation system for generating random numbers using pixel characteristics of an image sensor. In recognition of the issues above, the random number generation system based on some embodiments of the disclosed technology can generate random numbers using pixel characteristics of the image sensor, such that the random number generation system has excellent randomness with high unpredictability and provides an effect of facilitating device implementation.

Reference will now be made in detail to the embodiments of the disclosed technology, examples of which are illustrated in the accompanying drawings. Wherever possible, the same reference numbers will be used throughout the drawings to refer to the same or like parts. While the disclosure is susceptible to various modifications and alternative forms, specific embodiments thereof are shown by way of example in the drawings. However, the disclosure should not be construed as being limited to the embodiments set forth herein.

Hereafter, various embodiments will be described with reference to the accompanying drawings. However, it should be understood that the disclosed technology is not limited to specific embodiments, but includes various modifications, equivalents and/or alternatives of the embodiments. The embodiments of the disclosed technology may provide a variety of effects capable of being directly or indirectly recognized through the disclosed technology.

Various embodiments of the disclosed technology relate to a random number generation system for generating random numbers using pixel characteristics of an image sensor. It is to be understood that both the foregoing general description and the following detailed description of the disclosed technology are illustrative and explanatory and are intended to provide further explanation of the disclosure as claimed.

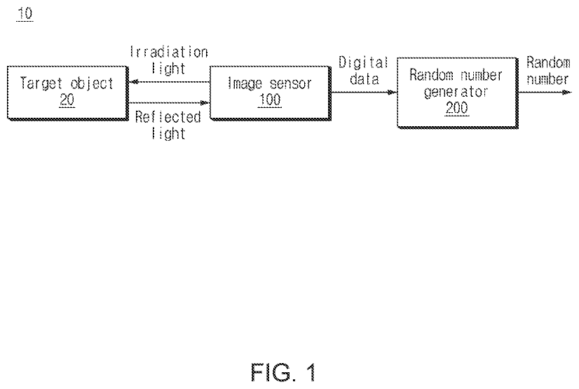

FIG. 1 is a block diagram illustrating an example of a random number generation system 10 using an image sensor based on some embodiments of the disclosed technology.

Referring to FIG. 1, the random number generation system 10 may include an image sensor 100 and a random number generator 200.

Here, the image sensor 100 may radiate light of a preset frequency to an object (e.g., a target object to be measured) 20, may detect a phase difference between the irradiated light and the reflected light that is reflected from the target object 20 and returned, and may thus measure a distance to the target object 20.

Also, the image sensor 100 based on some embodiments of the disclosed technology may generate digital data using a component of charges distributed to floating diffusion (FD) node(s) (to be described later) of pixels. In other words, the image sensor 100 may adjust the ratio of charges to be distributed to the floating diffusion (FD) nodes of the pixels in response to the above-described phase difference, and may thus generate digital data. Digital data generated by the image sensor 100 may be transferred to the random number generator 200.

In some embodiments, the image sensor 100 may include a time of flight (TOF)-based sensor. A method for measuring the distance to the target object using the TOF sensor has become popular because of its wide range of utilization, high processing speed, and cost advantages.

The TOF method measures a distance using emitted light and reflected light. The TOF method may be roughly classified into a direct method and an indirect method, depending on whether it is a round-trip time or the phase difference that determines the distance.

The direct method may calculate a round trip time using emitted light and reflected light and measure the distance to the target object using the calculated round trip time. The indirect method may measure the distance to the target object using a phase difference. The direct method is suitable for long-distance measurement and thus is widely used in automobiles. The indirect method is suitable for short-distance measurement and thus is widely used in various higher-speed devices designed to operate at a higher speed, for example, game consoles, mobile cameras, or others. As compared to the direct type TOF systems, the indirect method has several advantages, including having simpler circuitry and a relatively low cost.

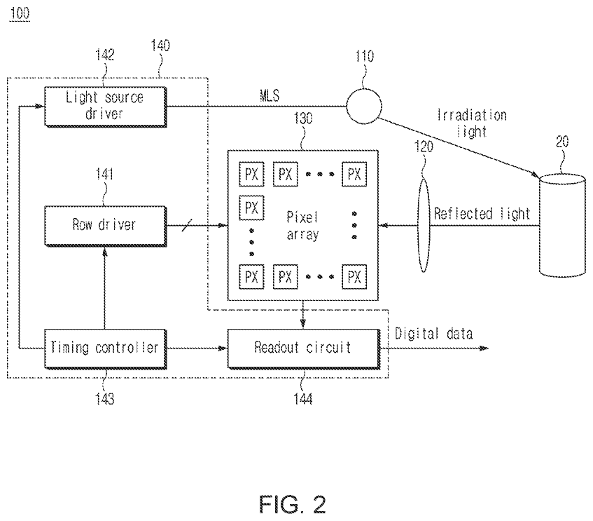

In some embodiments of the disclosed technology, the image sensor 100 implemented as an indirect TOF sensor will be described as an example for convenience of description, and a detailed description of constituent elements of the image sensor 100 will be given later with reference to FIG. 2.

The random number generator 200 may generate random numbers by receiving digital data generated by the image sensor 100. Here, the random numbers may refer to different and unpredictable random numbers, that is, randomly generated numbers. In some embodiments, the random number generator 200 may generate random numbers using digital data provided from the image sensor 100 using a random extraction program. In some embodiments, the random number generator 200 may refer to a deterministic random bit generator (DRBG).

The deterministic random bit generator (DRBG) may refer to a device or algorithm for generating random numbers using a deterministic algorithm. Here, the deterministic algorithm may refer to an algorithm having unique characteristics in which the same output is always generated for the same input. Representative examples of such deterministic random bit generators (DRBG) may include a block cipher-based deterministic random bit generator (DRBG), a hash function-based deterministic random bit generator (DRBG), and a hash-based message authentication code (HMAC)-based deterministic random bit generator (DRBG). Here, the block cipher-based DRBG may refer to a deterministic random bit generator (CTR_DRBG) using a counter mode of the block cipher. The hash function-based DRBG may refer to a deterministic random bit generator (hash_DRBG) using the hash function. The HMAC-based DRBG may refer to a deterministic random bit generator (HMAC_DRBG) using the HMAC algorithm.

Although various examples of the random number generator 200 have been described above, the type of the random number generator 200 is not limited thereto and can be sufficiently changed in the embodiment of the disclosed technology.

In some embodiments, since digital data having random characteristics corresponding to digital data output from the image sensor 100 is used as a seed value of the random number generator 200, a random number generation system can be implemented without changing separate hardware.

FIG. 2 is a block diagram illustrating an example of the image sensor 100 shown in FIG. 1 based on some embodiments of the disclosed technology.

Referring to FIG. 2, the image sensor 100 may include a light source 110, a lens module 120, a pixel array 130, and a control block 140.

Here, the light source 110 may emit light to a target object 20 upon receiving a modulated light signal (MLS) from the control block 140. Although FIG. 2 shows only one light source 110 for convenience of description, other embodiments are also possible. For example, a plurality of light sources may also be arranged around the lens module 120.

The light source 110 may include a light emitting device. For example, the light source 110 may be a laser diode (LD) or a light emitting diode (LED) for emitting light (e.g., near infrared (NIR) light, infrared (IR) light or visible light) having a specific wavelength band, or may be any one of a Near Infrared Laser (NIR), a point light source, a monochromatic light source combined with a white lamp or a monochromator, and a combination of other laser sources. Light emitted from the light source 110 may be light (i.e., modulated light) modulated by a predetermined frequency.

In some embodiments, since the image sensor 100 calculates phase difference information using light (i.e., emitted light) irradiated from the light source 110 and light (i.e., reflected light) reflected from the target object 20, the image sensor 100 may necessarily include the light source 110 for emitting light to the target object 20. Accordingly, in some embodiments, since the light source 110 is present in the image sensor 100, a value serving as a seed of the random number generator 200 can be extracted regardless of the presence or absence of natural light.

The lens module 120 may collect light reflected from the target object 1, and may allow the collected light to be focused onto unit pixels (PXs) of the pixel array 130. For example, the lens module 120 may include a focusing lens having a surface formed of glass or plastic or another cylindrical optical element having a surface formed of glass or plastic. The lens module 120 may include a plurality of lenses that is arranged to be focused upon an optical axis.

The pixel array 130 may convert light sensed from the outside into an analog signal that is an electrical signal. Here, the light sensed from the outside may include reflected light in which light output from the light source 110 is reflected from the target object 20.

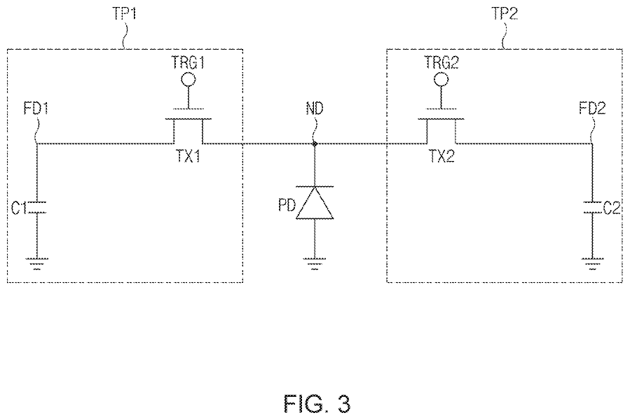

The pixel array 130 may include a plurality of unit pixels (PXs) consecutively arranged in a two-dimensional (2D) matrix structure in which the unit pixels (PXs) are arranged in a column direction and a row direction perpendicular to the column direction. The unit pixel (PX) may be a minimum unit in which the same shape is repeatedly arranged in the pixel array 130. In some embodiments, when the pixel array 130 includes a unit pixel (PX) having a 2-tap structure (for example, a unit pixel structure shown in FIG. 3 to be described later), two column lines for transmitting the pixel signal may be assigned to each column of the pixel array 130, and structures for processing the pixel signal generated from each column line may be configured to correspond to the respective column lines.

The unit pixels (PXs) may be formed over a semiconductor substrate. Each unit pixel (PX) may convert incident light received through the lens module 120 into an electrical signal corresponding to the intensity of incident light, and may thus output a pixel signal using the electrical signal. In this case, the pixel signal may be a signal indicating the distance to the target object 20. In some embodiments, the pixel signal may be a signal representing the ratio of the amount of charges to be distributed to the floating diffusion (FD) nodes of the unit pixel (PX).

The unit pixels (PXs) may generate pixel signals by sensing light from the outside during a sensing time. Due to the distance between the image sensor 100 and the target object 20, reflected light incident upon each of the unit pixels (PX) may be delayed in time compared to light output from the light source 110. Accordingly, a time difference (time delay) may occur between the light output from the light source 110 and the reflected light incident upon each of the unit pixels (PX). The time difference (time delay) may be denoted by a phase difference between a signal generated by the image sensor 100 and the modulated light signal (MLS) that controls the light source 110. An image signal processor (not shown) may calculate a distance between the target object 20 and the image sensor 100 using the phase difference. In some embodiments, the ratio of the amount of charges to be distributed to the floating diffusion (FD) nodes of the unit pixel (PX) may be randomly adjusted in response to the phase difference.

The control block 140 may emit light to the target object 20 by controlling the light source 110, and may process each pixel signal corresponding to light reflected from the target object 20 by driving unit pixels (PXs) of the pixel array 30.

The control block 140 may include a row driver 141, a light source driver 142, a timing controller 143, and a readout circuit 144.

In this case, the row driver 141 may drive the unit pixels (PXs) of the pixel array 130 in response to a timing signal generated from the timing controller 143. For example, the row driver 141 may generate a control signal capable of selecting and controlling at least one row line from among the plurality of row lines. The control signal may include a transfer signal (TRG) for controlling transmission of photocharges accumulated in a detection region.

The light source driver 142 may generate a modulated light signal (MLS) capable of driving the light source 110 in response to a control signal from the timing controller 143. The modulated light signal (MLS) may be a signal that is modulated by a predetermined frequency. For example, the modulated light signal (MLS) may have a shape of square waves (light pulses) or a shape of sine waves. The word “predetermined” as used herein with respect to a parameter, such as a predetermined frequency and predetermined mode, means that a value for the parameter is determined prior to the parameter being used in a process or algorithm. For some embodiments, the value for the parameter is determined before the process or algorithm begins. In other embodiments, the value for the parameter is determined during the process or algorithm but before the parameter is used in the process or algorithm.

The timing controller 143 may generate control signals to control the row driver 141, the light source driver 142, and the readout circuit 144. For example, the timing controller 143 may generate clock signals and timing control signals for operations of the row driver 141, the light source driver 142, and the readout circuit 144.

The readout circuit 144 may process analog signals output from the pixel array 130 under control of the timing controller 143, and may thus generate digital data. To this end, the readout circuit 144 may include an analog-to-digital converter (ADC). Digital data output from the readout circuit 144 may be transferred to the random number generator 200.

In some embodiments, the readout circuit 144 may include a buffer circuit that temporarily stores or stores digital data generated from the analog-to-digital converter (ADC). In some embodiments, the readout circuit 144 may output digital data including distance information to the outside (e.g., a processor) under control of the timing controller 143.

FIG. 3 is a circuit diagram illustrating an example of the unit pixel (PX) of the image sensor 100 shown in FIG. 2 based on some embodiments of the disclosed technology.

Referring to FIG. 3, the unit pixel (PX) may include a photoelectric conversion element PD, a first tap TP1, and a second tap TP2.

Here, the photoelectric conversion element PD may generate charges based on light (external light) received from the outside. Charges generated by the photoelectric conversion element PD may be distributed to the first tap TP1 and the second tap TP2. One photoelectric conversion element PD may be shared by the first tap TP1 and the second tap TP2. That is, the photoelectric conversion element PD may be electrically connected to the first tap TP1 and the second tap TP2. For example, the photoelectric conversion element PD may include a photodiode for converting an optical signal into an electrical signal. The photodiode may include an anode connected to a ground voltage terminal (as shown in FIG. 3) and a cathode connected to a node ND.

The first tap TP1 may include a first transfer transistor TX1 and a first capacitor C1. The first transfer transistor TX1 may be connected between the floating diffusion node FD1 and the node ND to receive the first transfer signal TRG1 through a gate terminal thereof. The first transfer transistor TX1 may be activated to enter an active state in response to the first transfer signal TRG1 supplied to a gate terminal thereof, such that the node ND and the floating diffusion node FD1 can be electrically connected to each other. The first transfer transistor TX1 may be turned on during a sensing time based on the first transfer signal TRG1, and may be turned off during the remaining time other than the sensing time. The first transfer signal TRG1 may be provided from the row driver 141. Also, the first capacitor C1 may be connected between the floating diffusion node FD1 and the ground voltage terminal (as shown in FIG. 3).

The second tap TP2 may include a second transfer transistor TX2 and a second capacitor C2. The second transfer transistor TX2 may be connected between the floating diffusion node FD2 and the node ND to receive the second transfer signal TRG2 through a gate terminal thereof. The second transfer transistor TX2 may be activated to enter an active state in response to the second transfer signal TRG2 supplied to a gate terminal thereof, such that the node ND and the floating diffusion node FD2 can be electrically connected to each other. The second transfer transistor TX2 may be turned on during a sensing time based on the second transfer signal TRG2, and may be turned off during the remaining time other than the sensing time. The second transfer signal TRG2 may be provided from the row driver 141. Also, the second capacitor C2 may be connected between the floating diffusion node FD2 and the ground voltage terminal (as shown in FIG. 3).

With the above-described configuration, charges generated in one photoelectric conversion element PD (photodiode) may be transferred to two floating diffusion nodes (FD1, FD2) through the transfer transistors (TG1, TG2), such that the charges can be distributed to and accumulated in the two capacitors (C1, C2). The first tap TP1 and the second tap TP2 may generate a voltage according to the amount of charges accumulated in the two capacitors (C1, C2), and may output a first pixel signal and a second pixel signal.

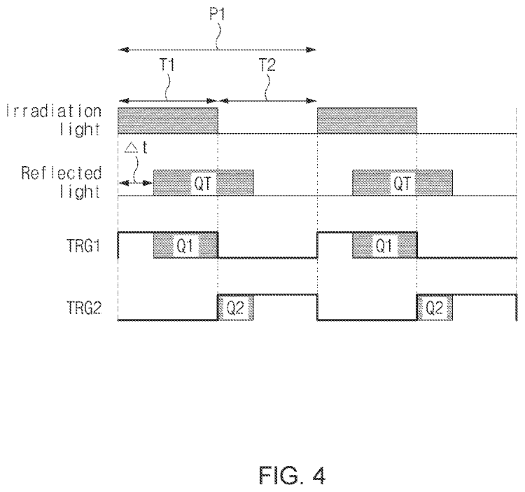

FIG. 4 is a timing diagram illustrating example operations of the unit pixel shown in FIG. 3 based on some embodiments of the disclosed technology.

Referring to FIG. 4, the image sensor 100 may use the light source 110 to emit light (irradiation light) of a random frequency to the target object 20 during an irradiation time T1 of a random period P1. The image sensor 100 might not emit irradiation light to the target object 20 during a non-irradiation time T2 of the random period P1. The image sensor 100 may use the lens module 120 to receive reflected light from the target object 20 during a time period corresponding to the irradiation time T1. The image sensor 100 might not receive reflected light during a time period corresponding to the non-irradiation time T2. The irradiation time T1 and the non-irradiation time T2 may be identical to each other. There may be a time difference between the irradiation time of the irradiation light and the reception time of the reflected light. Here, the time difference may be denoted by a time (Δt) corresponding to the distance to the target object 20.

Each of the unit pixels (PXs) included in the image sensor 100 may include at least two transfer transistors (i.e., TX1 and TX2). The two transfer transistors (i.e., TX1 and TX2) may be turned on or off by the transfer signals TRG1 and TRG2. In more detail, the first transfer transistor TX1 may be turned on or off by the transfer signal TRG1, and the second transfer transistor TX2 may be turned on or off by the transfer signal TRG2. The transfer signal TRG1 may have a phase opposite to that of the transfer signal TRG2.

For example, the first transfer transistor TX1 may be turned on during the irradiation time T1 of the random period P1, and may be turned off during the non-irradiation time T2. Also, the second transfer transistor TX2 may be turned off during the irradiation time T1 of the random period P1, and may be turned on during the non-irradiation time T2.

Accordingly, the at least two capacitors (C1, C2) may store and accumulate charge amounts (Q1, Q2) corresponding to the amount of incident reflected light while the transfer transistors (TX1, TX2) are turned on. In more detail, the capacitor C1 may store and accumulate the amount of charges Q1 corresponding to the amount of incident reflected light while the first transfer transistor TX1 is turned on, and the capacitor C2 may store the amount of charges Q2 corresponding to the amount of incident reflected light while the transfer transistor TX2 is turned on. Here, the charges accumulated in the two capacitors C1 and C2 may refer to charges generated in response to light received by the photoelectric conversion element PD.

Each of the unit pixels (PXs) may output charges accumulated in two capacitors (C1, C2). That is, each unit pixel (PX) may output pixel signals (e.g., a first pixel signal and a second pixel signal) corresponding to electrons transferred to the floating diffusion nodes. Thereafter, the readout circuit 144 of the image sensor 100 may convert the pixel signals into digital data, such that the readout circuit 144 may transmit distance data indicating the distance between the image sensor 100 and the target object 20 to the external device such as a processor or may transmit distance information indicating a time difference (Δt) to the external device such as a processor.

In some embodiments, the readout circuit 144 of the image sensor 100 may convert pixel signals corresponding to the ratio of the charge amounts Q1 and Q2 into digital data, and may provide the digital data as a seed value of the random number generator 200.

The total charge QT (i.e., a total of charges) corresponding to the amount of light reflected from the unit pixel (PX) of the image sensor 100 may be denoted by the sum of the charge Q1 accumulated in the capacitor C1 and the charge Q2 accumulated in the capacitor C2.

Whereas the total charge QT, which is the sum of the charge Q1 and the charge Q2, can be set by the irradiation light and the reflected light, the ratio of the charge Q1 to the charge Q2 corresponding to the time difference (Δt) between the irradiation time point of the irradiation light and the reception time point of the reflected light may have a random value for each unit pixel (PX). That is, the total charge QT is the same in each of the unit pixels (PXs), but the ratio between the charge Q1 and the charge Q2 may vary randomly depending on a time of flight (TOF). The ratio between the charge Q1 and the charge Q2 that have such randomness may be generated as pixel data of each unit pixel PX, and the pixel data may be converted into digital data, so that the digital data can be transmitted to the random number generator 200.

In addition, the charge Q1 accumulated in the capacitor C1 and the charge Q2 accumulated in the capacitor C2 may include noise. That is, the pixel signal corresponding to electrons transmitted to the floating diffusion node FD1 and the pixel signal corresponding to electrons transmitted to the floating diffusion node FD2 may include noise.

For example, quantum shot noise may occur in each unit pixel (PX) according to the uncertainty of the number of photons generated by particle characteristics of the light possessed by the light source.

As another example, the unit pixel (PX) may include a photoelectric conversion element PD (shown in FIG. 3) using a photodiode of a P-N junction structure, and the photodiode may be designed to operate in a reverse bias. A depletion region may be formed in the middle of the P-N junction of the photodiode. A deterioration phenomenon may occur in such a depletion region, so that noise may occur.

The pixel signal corresponding to electrons transferred to the floating diffusion node FD1 and the pixel signal corresponding to electrons transferred to the floating diffusion node FD2 may cause noise for various reasons other than quantum shot noise and noise caused by the above deterioration phenomenon. In this way, the charge Q1 including noise may be transmitted to the floating diffusion node FD1, and the charge Q2 including noise may be transmitted to the floating diffusion node FD2, so that the pixel signals including such random noise may occur.

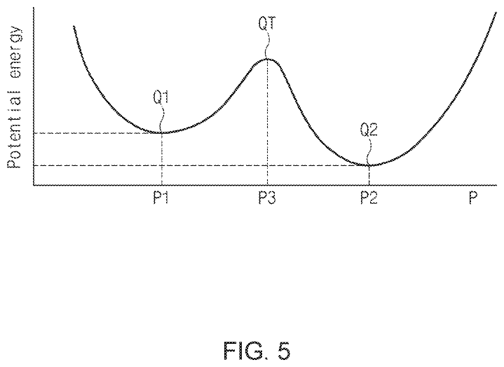

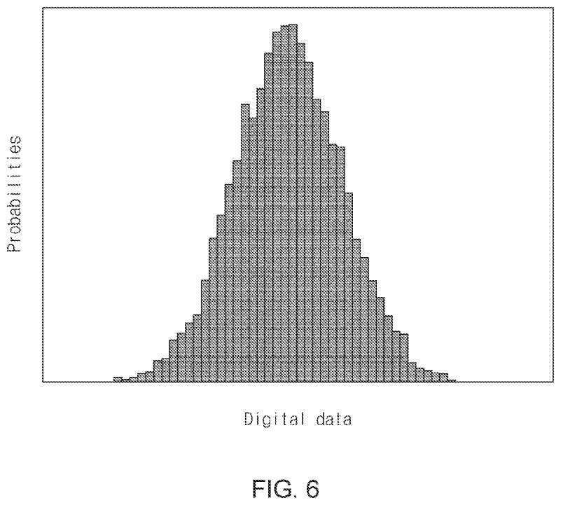

FIG. 5 is a diagram illustrating an example of potential energy of the unit pixel shown in FIG. 3 based on some embodiments of the disclosed technology. FIG. 6 is a diagram illustrating an example of Poisson distribution of the unit pixel shown in FIG. 3 based on some embodiments of the disclosed technology. Here, Poisson distribution may represent a probability model for the number of occurrences of a certain event in a given time or area. In an embodiment of the disclosed technology, the Poisson distribution may represent a distribution value of a total amount of charge with respect to the output (digital data) of the image sensor.

Referring to FIG. 5, a horizontal axis may represent a period in which light is irradiated onto an image sensor, and a vertical axis may represent potential energy of a unit pixel. Potential energy of the total charge QT at the time point P3 may be denoted by the sum of potential energy of the charge Q1 at the time point P1 and potential energy of the charge Q2 at the time point P2. That is, the sum of the electrons accumulated in the floating diffusion node FD1 and the electrons accumulated in the floating diffusion node FD2 may be equal to the total number of electrons accumulated in the node ND. However, the number of electrons to be distributed to the floating diffusion node FD1 and the floating diffusion node FD2 may vary randomly depending on light reception conditions.

Referring to FIG. 6, a horizontal axis may represent an output (digital data) of an image sensor, and a vertical axis may represent a distribution value of a total charge amount. During a specific time in each unit pixel (PX) of the image sensor 100, the ratio of the charge Q1 accumulated in the capacitor C1 to the charge Q2 accumulated in the capacitor C2 may be used as a seed value of the random number generator 200. That is, the ratio of the charge Q1 to the charge Q2 may be a source of randomness.

Particularly, the ratio of the charge Q1 to the charge Q2 is established differently for each unit pixel (PX), but the total charge QT may be the same in the respective unit pixels (PXs). However, depending on the uncertainty of the number of photons in each unit pixel (PX), quantum shot noise or other noise caused by deterioration may occur. In this way, noise and the total charge QT may be transferred to the floating diffusion nodes FD1 and FD2, so that pixel signals each having random noise may occur. That is, the value of each pixel signal may be denoted by the sum of the total charge QT and the noise. Since the amount of noise is changed according to each unit pixel (PX), the respective pixel signals may have different values.

As such, values (i.e., digital data) of pixel signals including different noises may be depicted to follow a Poisson distribution. In FIG. 6, a horizontal axis may denote output signals (i.e., digital data) of the image sensor 100, and a vertical axis may denote numerical values obtained by normalizing probabilities of frequency of use. In some embodiments, the value of the total charge (QT) including noise extracted from the image sensor 100, that is, the pixel signal (digital data) that is different for each unit pixel (PX), may be used as the seed value of the random number generator 200.

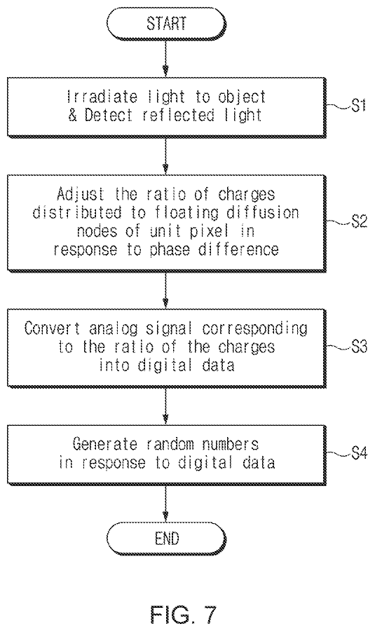

FIG. 7 is a flowchart illustrating an example method for generating random numbers using the image sensor based on some embodiments of the disclosed technology.

Referring to FIG. 7, the image sensor 100 may irradiate light to the target object 20 through the light source 110. Thereafter, the image sensor 100 may detect a phase difference between the irradiation light and the reflected light returned from the target object 20 (Operation S1).

When the image sensor 100 detects a phase difference between the irradiation light and the reflected light, the image sensor 100 may randomly adjust, in response to the detected phase difference, the ratio of the charge Q1 accumulated in the capacitor C1 of the unit pixel PX to the charge Q2 accumulated in the capacitor C2 of the unit pixel PX (Operation S2). In more detail, the charge Q1 and the charge Q2 are distributed to the floating diffusion nodes FD1 and FD2, and are accumulated in the capacitors C1 and C2, respectively. In addition, the ratio of the charge Q1 to the charge Q2 may randomly include a ratio of noise.

Subsequently, the readout circuit 144 of the image sensor 100 may convert the analog signal corresponding to the ratio of the charge Q1 to the charge Q2 into digital data by the analog-to-digital converter (ADC) (Operation S3). Then, the random number generator 200 may generate random numbers in response to the digital data received from the image sensor 100 (Operation S4).

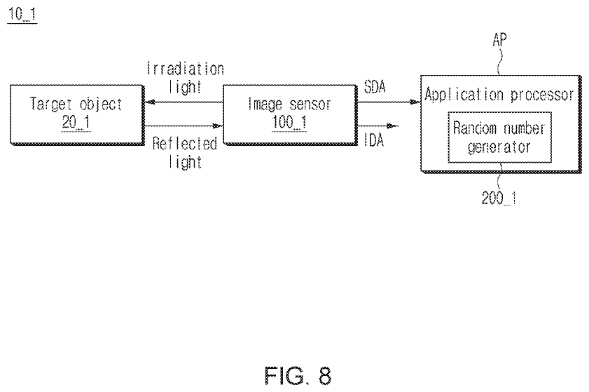

FIG. 8 is a block diagram illustrating an example of a random number generation system 10_1 using an image sensor 100_1 based on some other embodiments of the disclosed technology.

Referring to FIG. 8, the random number generation system 10_1 may include an image sensor 100_1 and a random number generator 200_1.

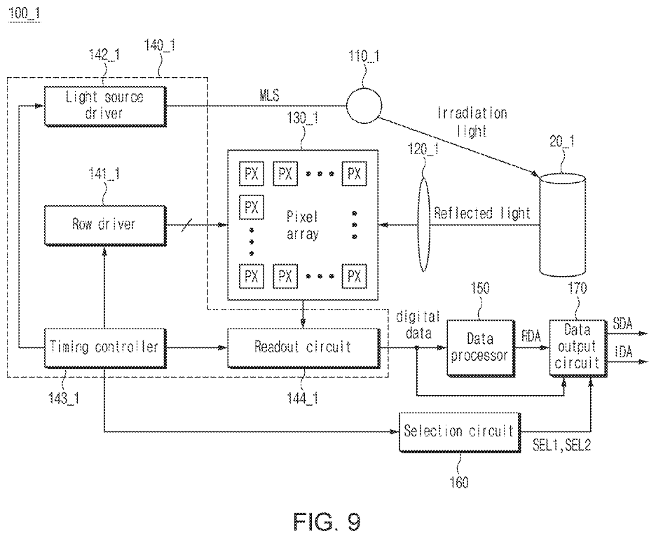

Referring to FIG. 8, the image sensor 100_1 may output image data IDA or seed data SDA in response to a mode established in a selection circuit (to be described later). The configuration and operations of the image sensor 100_1 shown in FIG. 1 compared to the image sensor of FIG. 1 will be described in detail with reference to FIG. 9 to be described later.

Referring to FIG. 8, the random number generator 200_1 may be included in an application processor (AP). The application processor (AP) may refer to a processing device that drives various application programs and performs graphic processing in a mobile communication terminal. When the mode established in the selection circuit (to be described later with reference to FIG. 9) is a random number generation mode, the random number generator 200_1 may generate random numbers by receiving seed data SDA from the image sensor 100_1.

FIG. 9 is a schematic diagram illustrating an example of the image sensor 100_1 shown in FIG. 8 based on some embodiments of the disclosed technology.

Referring to FIG. 9, the image sensor 100_1 may include a light source 110_1, a lens module 120_1, a pixel array 130_1, a control block 140_1, a data processor 150, a selection circuit 160, and a data output circuit 170.

The configurations of the light source 110_1, the lens module 120_1, the pixel array 130_1, and the control block 140_1 shown in FIG. 9 are the same as or similar to those of FIG. 2, the same or similar reference numerals are used in FIG. 9, and as such a detailed description thereof will herein be omitted for brevity.

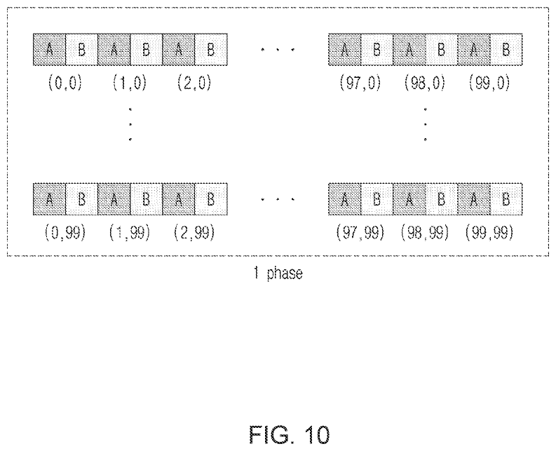

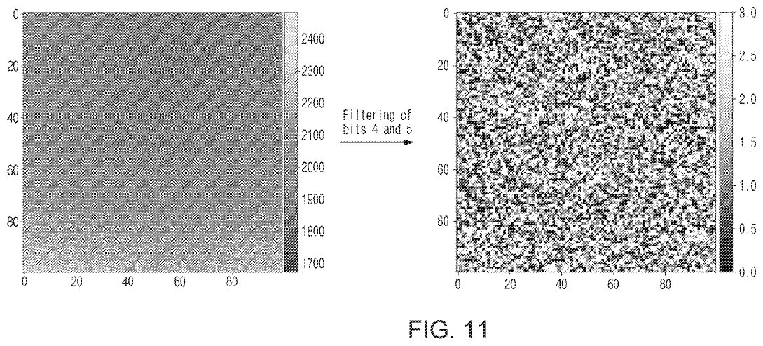

The data processor 150 may process digital data received from the control block 140_1, and may output the processed digital data to the data output circuit 170. For example, the data processor 150 may perform a noise sampling operation for sampling noise included in digital data. The data processor 150 may extract a specific bit value from the sampled data, and may output the extracted bit value to the data output circuit 170. The operation of the data processor 150 will be described in detail with reference to FIGS. 10 and 11 to be described later.

The selection circuit 160 may generate selection signals SEL1 and SEL2 for controlling the output of the data output circuit 170 in response to a predetermined mode. That is, the selection circuit 160 may output the selection signal SEL1 for selecting image data in a normal mode. In addition, in a random number generation mode, the selection circuit 160 may output the selection signal SEL2 for selecting random number data RDA. For example, the selection circuit 160 may include a mode register. Here, the output of the mode register may be controlled according to which mode is established.

Although the embodiment of FIG. 9 has disclosed that the selection circuit 160 is controlled by the timing controller 143_1 for convenience of description, other embodiments are also possible, and a register value may also be set by a separate input signal or logic value.

In addition, the data output circuit 170 may output image data IDA or seed data SDA in response to the selection signals SEL1 and SEL2 received from the selection circuit 160.

That is, when the selection signal SEL1 is activated in the normal mode, the data output circuit 170 may select digital data received from the control block 140_1 and output the selected digital data as image data IDA. The image data IDA output from the data output circuit 170 may include information indicating a distance between the target object 20_1 and the image sensor 100_1.

On the other hand, when the selection signal SEL2 is activated in the random number generation mode, the data output circuit 170 may select random number data RDA received from the data processor 150 and output the selected random number data RDA as seed data SDA. The seed data SDA output from the data output circuit 170 may be provided to the random number generator 200_1 and used as an entropy source.

FIGS. 10 and 11 are diagrams illustrating examples of the data processor shown in FIG. 9 based on some embodiments of the disclosed technology.

Referring to FIGS. 10 and 11, the data processor 150 may perform sampling of noise included in digital data received from the control block 140_1. In addition, the data processor 150 may output random number data RDA to the data output circuit 170 by extracting and filtering a specific bit value from the sampled data.

The data processor 150 may extract and filter a bit value of a specific digit from bit values of each digital data that satisfies the Poisson distribution described in FIG. 6 above. The random number data RDA processed by the data processor 150 may be transmitted to the random number generator 200_1 through the data output circuit 170, so that the random number data RDA may be used as seed data SDA for random number generation.

For example, as shown in FIG. 10, it may be assumed that a sampled value of digital data received from the control block 140_1 has a total of 16 bits. 4 bits from among a total of 16 bits may correspond to padding bits. Here, the padding bits may refer to bits that are arbitrarily added to match the size of data to be actually transmitted.

When the pixel array 130 includes (100×100) unit pixels (PXs) arranged in a column direction (COLUMN) and a row direction (ROW) as shown in FIG. 3, each of the unit pixels (PXs) is a two-tap (2-tap) structure, so that digital data can be extracted as a (200×100) matrix. In FIG. 10, ‘A’ may represent data extracted from the first tap TP1 described in FIG. 3 described above, and ‘B’ may represent data extracted from the second tap TP2 described in FIG. 3 described above.

As shown in FIG. 11, the horizontal axis and the vertical (left) axis may represent frames of digital data, and the vertical (right) axis may represent various conditions (eg, illuminance). The data processor 150 may extract N bits (e.g., 4 bits) and (N+1) bits (e.g., 5 bits) from among bit values of each digital data, and may filter the extracted N bits and (N+1) bits. When N bits and (N+1) bits are filtered, (100×100) matrix data to be randomly generated may be created. That is, when the extracted specific bits are filtered, the initial image pattern (see the left pattern of FIG. 11) may be removed and random number data RDA having a random pattern (see the right pattern of FIG. 11) having no regularity may be created, so that the random number data RDA can be used as an entropy source.

As is apparent from the above description, the random number generation system based on some embodiments of the disclosed technology can generate random numbers using pixel characteristics of the image sensor, such that the random number generation system has excellent randomness with high unpredictability and provides an effect of facilitating device implementation.

The embodiments of the disclosed technology may provide a variety of effects capable of being directly or indirectly recognized through the above-mentioned patent document.

Although a number of illustrative embodiments have been described, it should be understood that modifications and enhancements to the disclosed embodiments and other embodiments can be devised based on what is described and/or illustrated in this patent document.

What is claimed is:

1. An image sensor comprising:
a photoelectric conversion element configured to generate charges in response to light;
a first tap in which a first charge from among the charges generated by the photoelectric conversion element is accumulated; and
a second tap in which a second charge from among the charges generated by the photoelectric conversion element is accumulated,
wherein a ratio of the first charge to the second charge is adjusted in response to a phase difference between irradiation light emitted to a target object and reflected light, and pixel signals respectively corresponding to the first charge and the second charge are provided as a seed value for generating at least one random number.

2. The image sensor according to claim 1, wherein:
a ratio of the first charge to the second charge is randomly adjusted and provided as the seed value.

3. The image sensor according to claim 1, wherein:
the photoelectric conversion element is shared by the first tap and the second tap, and includes a photodiode,
wherein a cathode of the photodiode is coupled to a node to which the first tap and the second tap are commonly connected, and an anode of the photodiode is coupled to a ground voltage terminal.

4. The image sensor according to claim 1, wherein the first tap includes:
a first transfer transistor connected between the photoelectric conversion element and a first floating diffusion node to receive a first transfer signal through a gate terminal thereof; and
a first capacitor connected between the first floating diffusion node and a ground voltage terminal to accumulate the first charge therein.

5. The image sensor according to claim 4, wherein the second tap includes:
a second transfer transistor connected between the photoelectric conversion element and a second floating diffusion node to receive a second transfer signal having a phase opposite to that of the first transfer signal through a gate terminal thereof; and
a second capacitor connected between the second floating diffusion node and a ground voltage terminal to accumulate the second charge.

6. The image sensor according to claim 5, wherein:
a total of charges generated from the photoelectric conversion element is distributed to and accumulated in the first capacitor and the second capacitor.

7. The image sensor according to claim 5, wherein:
a total charge generated from the photoelectric conversion element is equal to a sum of the first charge and the second charge.

8. The image sensor according to claim 1, wherein:
each of the first charge and the second charge includes noise,
wherein
a ratio of noise included in the first charge to noise included in the second charge is provided as the seed value for generating the random number.

9. A random number generation system comprising:
an image sensor configured to include a plurality of unit pixels, emit irradiation light to a target object, adjust a ratio of charges to be distributed to floating diffusion nodes of each of the plurality of unit pixels in response to a phase difference between the irradiation light and a reflected light reflected from the target object, and generate seed data by processing digital data corresponding to the ratio of the charges; and
a random number generator configured to generate at least one random number in response to the seed data received from the image sensor.

10. The random number generation system according to claim 9, wherein the image sensor includes:
a pixel array configured to accumulate the charge corresponding to the phase difference in each of the plurality of unit pixels, and output a pixel signal corresponding to a ratio of the charges accumulated in each of the plurality of unit pixels;
a control block configured to output the digital data by controlling driving of the unit pixel;
a data processor configured to generate random number data by extracting a specific bit value from the digital data; and
a data output circuit configured to select the digital data in response to at least one selection signal and output the selected digital data as image data, or to select the random number data and output the selected random number data as the seed data.

11. The random number generation system according to claim 10, wherein each of the plurality of unit pixels includes:
a photoelectric conversion element configured to generate charges in response to the reflected light; and
a plurality of taps to which the charges generated by the photoelectric conversion element are distributed and accumulated.

12. The random number generation system according to claim 11, wherein:
the charge includes noise; and
a ratio of noise of charges distributed to each of the plurality of taps is provided to the pixel signal.

13. The random number generation system according to claim 11, wherein:
in each of the plurality of unit pixels, a total charge generated in the photoelectric conversion element is substantially the same.

14. The random number generation system according to claim 13, wherein:
a distribution of the total charge corresponds to a Poisson distribution.

15. The random number generation system according to claim 10, wherein the image sensor further includes:
a selection circuit configured to activate a first selection signal for selecting the image data from among the selection signals during a normal mode, and to activate a second selection signal for selecting the random number data from among the selection signals during a random number generation mode.

16. The random number generation system according to claim 15, wherein the selection circuit includes:
a mode register in which the normal mode and the random number generation mode are established.

17. The random number generation system according to claim 10, wherein the data processor is configured to:
perform sampling of noise included in the digital data, filter a bit value of a specific digit from the sampled data, and generate the random number data.

18. The random number generation system according to claim 9, wherein:
the random number generator is included in an application processor.

19. An image sensor comprising:
a photoelectric conversion element configured to generate charges in response to light;
a first tap in which a first charge from among the charges generated by the photoelectric conversion element is accumulated; and
a second tap in which a second charge from among the charges generated by the photoelectric conversion element is accumulated,
wherein
a total charge accumulated in the first tap and the second tap is equal to a sum of the first charge and the second charge;
a ratio of the first charge to the second charge is adjusted in response to a phase difference between irradiation light emitted to a target object and reflected light; and
a ratio of noise included in the first charge to noise included in the second charge is provided as a seed value for generating at least one random number.

20. The image sensor according to claim 19, wherein:
a distribution of the total charge corresponds to a Poisson distribution.
